(19) United States
(12) Patent Application Publication
(10) Pub. No.: US 2009/0163070 A1
(43) Pub. Date: Jun. 25, 2009

(54) Electrical connector with metallic shell

(75) Inventor: Ji-Cheng Wang, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/317,406

(22) Filed: Dec. 22, 2008

(30) Foreign Application Priority Data
Dec. 21, 2007 (CN) 200720131651.X

(51) Int. Cl. H01R 13/625; H01R 24/04; H01R 13/62

(52) U.S. Cl. 439/350; 439/660; 439/345

(57) ABSTRACT

An electrical connector includes an insulating housing (1) having four side walls interconnecting with each other and defining a receiving space (10) therein. Only one of the side walls defines a plurality of terminal grooves therein and a plurality of terminals (22) are mounted in said terminal grooves. A metallic shell (4) covers on the insulating housing and said shell (4) has a first resilient arm (431) extending in a first direction with a first contacting portion (4311) bending outwardly, and a second resilient arm (432) extending in a reverse direction toward the first resilient arm with a second contacting portion (4321) bending outwardly. The first and second resilient arms (431, 432) space away from each other in a transverse direction perpendicular to said first direction, and said first and second contacting portions (4311, 4321) offset with each other in said first direction.

### BACKGROUND OF THE INVENTION

1. Field of the Invention

The present invention relates to an electrical connector, and particularly to an electrical connector with a metallic shell therearound.

2. Description of the Related Art

For an electrical connector, especially the electrical connector in the field of high frequency communication, a metallic shell is usually provided to reduce the influence of the electromagnetic interference (EMI) by mechanically and electrically contacting with a casing, which is used for accommodating the electrical connector. TW patents No. M289243 and M277149 respectively disclose such an electrical connector with a metallic shell forming with a pair of resilient arms thereon. The pair of resilient arms respectively extend from a front portion of a side wall along a front-to-rear direction for contacting with the casing so as to release the current centralized thereon. Because the pair of resilient arms are formed at the same side of the side wall, the electrical connector may incline toward the other side of the side wall when the electrical connector is received in the casing with the metallic shell contacting with the casing. Therefore, a steadily electrical contact can not be provided between the metallic shell of the electrical connector and the casing. Hence, an electrical connector is needed to solve the problem.

### SUMMARY OF THE INVENTION

Accordingly, an object of the present invention is to provide an electrical connector having a metallic shell therearound, and the metallic shell keeps a steadily electrical and mechanical contact with an outer device such as a casing.

In order to achieve the object set forth, an electrical connector comprises an insulating housing having four side walls interconnecting with each other and defining a receiving space therein. Only one of the side walls defines a plurality of terminal grooves therein and a plurality of terminals are mounted in said terminal grooves. A metallic shell covers on the insulating housing, and said shell has a first resilient arm extending in a first direction with a first contacting portion bending outwardly, and a second resilient arm extending in a reverse direction toward the first resilient arm with a second contacting portion bending outwardly. The first and second resilient arms space away from each other in a transverse direction perpendicular to said first direction, and said first and second contacting portions offset with each other in said first direction.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of an electrical connector in accordance with the present invention;

FIG. 2 is an exploded view of the electrical connector shown in FIG. 1;

FIG. 3 is another perspective view of the electrical connector shown in FIG. 1;

FIG. 4 is an exploded view of the electrical connector shown in FIG. 3; and

FIG. 5 is a perspective view of a terminal module mounted on a retaining device.

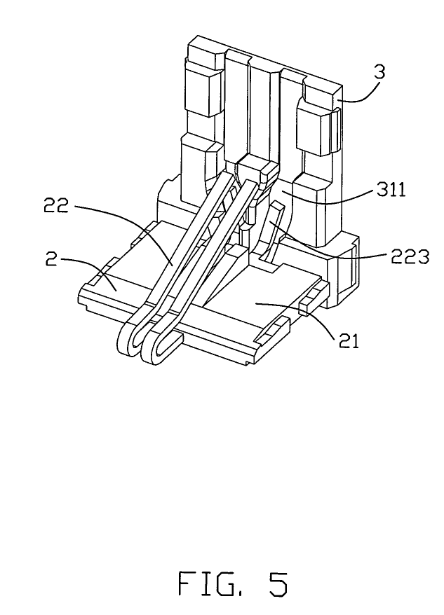

### DETAILED DESCRIPTION OF THE INVENTION

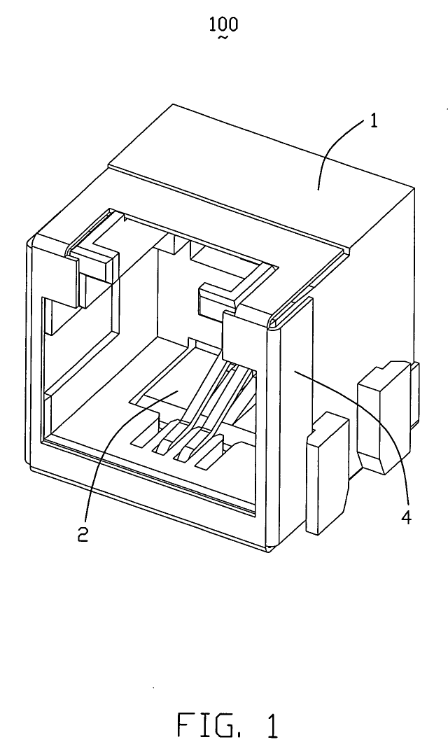

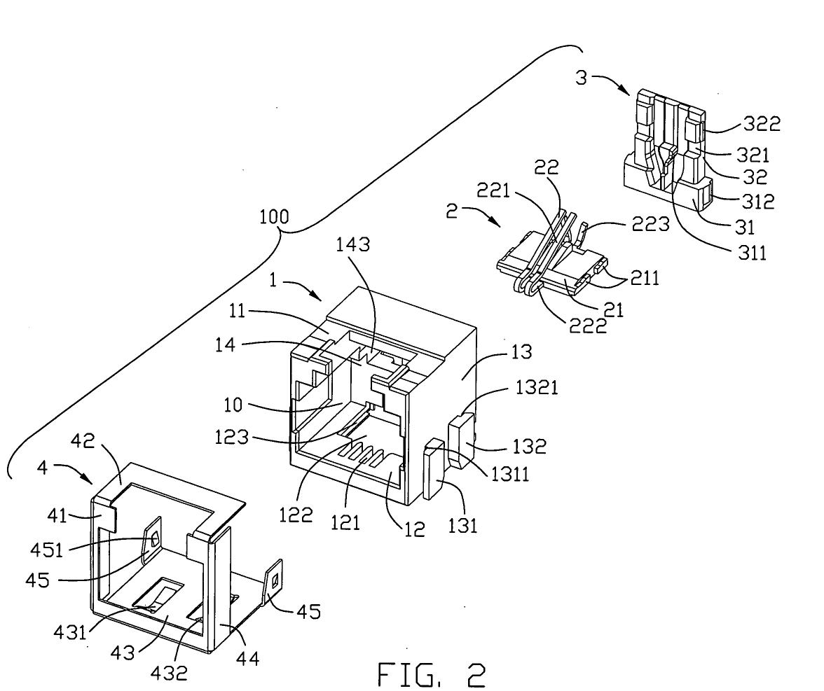

Reference will now be made to the drawing figures to describe a preferred embodiment of the present invention in detail. Referring to FIGS. 1 and 2, an electrical connector 100 according to the preferred embodiment of the present invention is provided and comprises an insulating housing 1, a terminal module 2 received in the insulating housing, a retaining device 3 and a metallic shell 4 covering on the insulating housing.

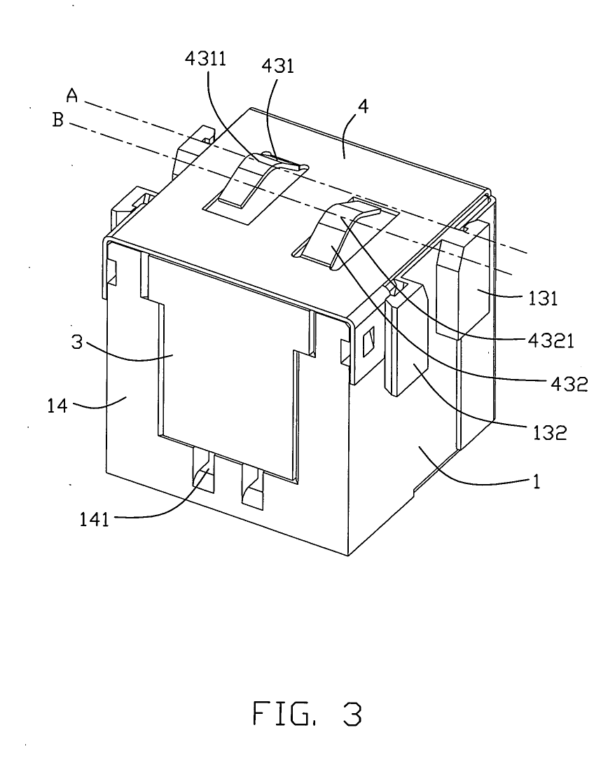

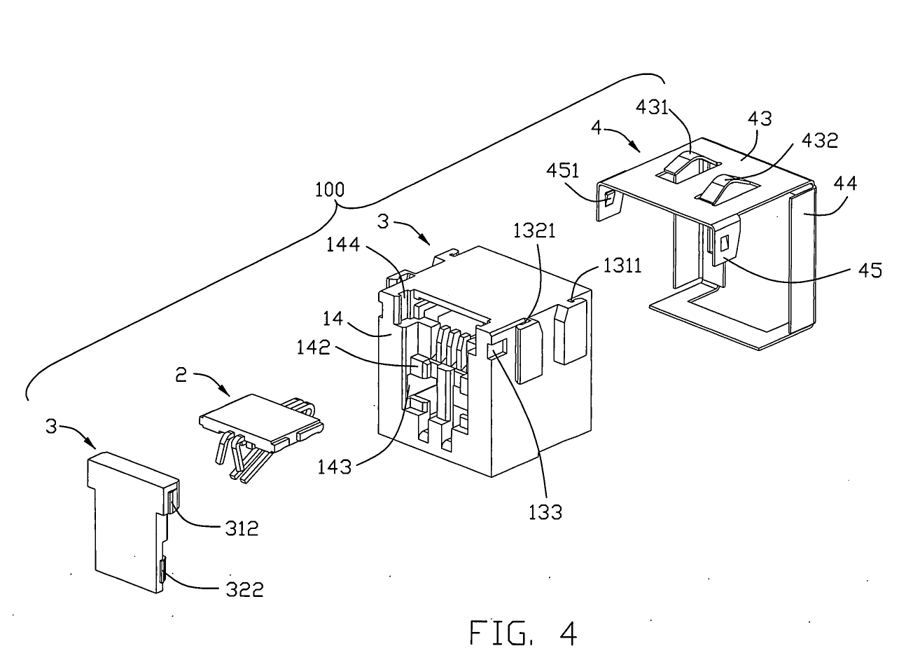

Referring to FIGS. 2 and 4, the insulating housing comprises an upper wall 11, a lower wall 12 opposite the upper wall 11, a pair of side walls 13 and a rear wall 14 interconnecting said upper wall, lower wall and side walls. A plurality of terminal receiving grooves 121 are arranged at intervals and extend rearward from a front portion of an inner side of the lower wall 12. A receiving cavity 122 is defined at a rear portion of the receiving grooves 121 and excavated downwardly in the lower wall 12, and a pair of locking passageways 123 are respectively defined at opposite sides of the receiving cavity in the same extending direction of the receiving grooves. A pair of protrusions 131,132 are respectively formed on each side wall 13 and each protrusion defines a channel 1311, 1321 therein. An aperture 133 is respectively formed at a rear portion of each side wall adjacent the protrusions 131, 132. Referring to FIG. 3, an opening 141 is defined in the rear wall 14 for allowing the cables to be inserted therein.

The terminal module 2 comprises a holding portion 21 and a plurality of conductive terminals 22 mounted therein. Each terminal 22 comprises a contacting portion 221 for electrically contacting with a mating connector (not shown), a connecting portion 222 extending from one end of the contacting portion 221 and secured in the holding portion 21, and a soldering portion 223 extending from one end of connecting portion 222 upwardly and outwardly. Moreover, the contacting portion 221 extends upwardly and slantwise from one end of the connecting portion 222, while the soldering portion 223 extends from the other end of connecting portion 222 slantwise and outwardly, therefore the distance between the adjacent soldering portions 223 are larger than that of the connecting portion 222. A pair of ribs 211 are respectively formed on each side of the holding portion 21.

The retaining device 3 comprises a base portion 31 and a body portion 32 extending upwardly from the base portion 31. A pair of slots 311 extend from a middle portion of the base portion 31 till the end of the body portion 32 for receiving a cable (not shown). A pair of apertures 321 are respectively formed at opposite sides of the body portion 32 to accommodate corresponding blocks 142 formed on the rear wall 14. Two pairs of blocks 312, 322 are respectively formed on sides of the base portion 31 and body portion 32 to cooperate with the grooves 143, 144 defined in the rear wall 14.

Referring to FIGS. 2 and 3, the metallic shell 4 comprises a front wall 41, an upper wall 42 and a bottom wall 43 extending rearward from opposite sides of the front wall 41, a pair of first pieces 44 extending rearward from right and left sides of the front wall 41, and a pair of second pieces 45 extending upward from opposite sides of the rear portion of the bottom wall 43. Each second piece 45 comprises a locking portion 451 therein. A first resilient arm 431 extends from a front portion of the bottom wall 43 along a front-to-rear direction and bends outwardly to form a first curved contacting portion 4311 below the bottom wall 43 thereof. A second resilient arm 432 extends from a rear portion of the bottom wall 43 along a rear-to-front direction and bends outwardly to form a second curved contacting portion 4321 below the bottom wall 43 thereof. The first and second resilient arms 431, 432 extend in opposite direction and space away from each other in a transverse direction perpendicular to the front-to-rear direction. The first and second curved contacting portions 4311, 4321 offset to each other in the front-to-rear direction (as shown in FIG. 3, the first and second curved contacting portion 4311, 4321 are respectively defined on the lines A and B).

When the electrical connector is assembled, the terminal module 2 is inserted into the receiving cavity 122 with ribs 211 fixed in the locking passageways 123 and connecting portion 222 received in the terminal groove 121. The retaining device 3 is received in the opening 141 on the rear wall 14 and abuts against the terminal module 2, meanwhile the blocks 312,322 are respectively received in the grooves 143, 144, the blocks 142 are secured in the apertures 321, and the soldering portions 223 are retained in the slots 311. The metallic shell 4 covers on the insulating housing 1 with the first pieces 44 and second pieces 45 respectively received in the channels 1311, 1321, and locking portions 451 locked with apertures 133.

As the first and second resilient arms 431, 432 extend from opposite sides of the bottom wall 43 and dispose offset with each other in the front-to-rear direction, when the electrical connector is assembled in an outer device such as a casing, the first and second resilient arms 431, 432 can mechanically and electrically contact with the casing in a good balance state so as to release the current centralized thereon.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector comprising:
an insulating housing having four side walls interconnecting with each other and defining a receiving space therein, only one of the side walls defining a plurality of terminal grooves therein;
a plurality of terminals mounted in said terminal grooves; and
a metallic shell covering on the insulating housing, said shell having a first resilient arm extending in a first direction with a first contacting portion bending outwardly, and a second resilient arm extending in a reverse direction toward the first resilient arm with a second contacting portion bending outwardly;
wherein the first and second resilient arms space away from each other in a transverse direction perpendicular to said first direction, and said first and second contacting portions offset with each other in said first direction.

2. The electrical connector as described in claim 1, wherein the shell has a bottom wall, the first and second contacting portions respectively extend from opposite ends of the bottom wall.

3. The electrical connector as described in claim 2, wherein the first and second contacting portions are in curved shapes.

4. The electrical connector as described in claim 1, wherein a receiving space is defined at a rear portion of the terminal grooves, said terminals are retained in a holding portion thereby forming a terminal module, said terminal module is received in said receiving space.

5. The electrical connector as described in claim 4, wherein the housing comprises a retaining device located at rear of the side walls and abutting against the terminal module.

6. The electrical connector as described in claim 1, wherein the shell comprises a front wall, an upper wall and a bottom wall extending rearward from opposite sides of the front wall, a pair of first pieces extending rearward from right and left sides of the front wall, and a pair of second pieces extending upward from opposite sides of the rear portion of the bottom wall.

7. The electrical connector as described in claim 6, wherein the first and second resilient arms are formed in the bottom wall, and each of the second piece has a locking portion to retain in an aperture defined on the side wall of the housing.

8. An electrical connector adapted for being assembled into an outer device, comprising:
an insulating housing defining a receiving cavity therein;
a terminal module received in said receiving cavity; and
a metallic shell covering on said insulating housing and forming a first and second resilient arms extending reversely from opposite sides of the shell, and each defining a contacting portion offsetting with each other so as to mechanically and electrically contacting with said outer device in a balance state.

9. The electrical connector as described in claim 8, wherein the shell defines a pair of locking devices to lock with apertures defined on the side walls.

10. The electrical connector as described in claim 8, wherein the terminal module comprises a holding portion mounted a plurality terminals therein, and each terminal comprises a connecting portion received in a corresponding terminal groove defined on the housing.

11. An electrical connector comprising:
an insulative housing defining at least one exterior surface;
a metallic shell defining at least one plate covering said exterior surface;
wherein
a pair of tangs having essentially a same dimension and unitarily stamped from said plate in a side by side relation while in opposite directions along a front-to-back direction.

12. The electrical connector as claimed in claim 11, wherein an apex of one of said pair of tangs is offset from that of the other in said front-to-back direction.
